(19) United States
(12) Patent Application Publication
(10) Pub. No.: US 2025/0284769 A1
(43) Pub. Date: Sep. 11, 2025

(54) ARITHMETIC PROCESSING DEVICE AND ARITHMETIC PROCESSING METHOD

(71) Applicant: Fujitsu Limited, Kawasaki-shi (JP)

(72) Inventors: Toshihiro SHIMIZU, Sagamihara (JP); Katsuhiro YODA, Kodaira (JP); Makiko ITO, Kawasaki (JP)

(73) Assignee: Fujitsu Limited, Kawasaki (JP)

(21) Appl. No.: 19/000,326

(22) Filed: Dec. 23, 2024

(30) Foreign Application Priority Data
Mar. 5, 2024 (JP) 2024-032999

(51) Int. Cl. G06F 17/16

(52) U.S. Cl. CPC G06F 17/16

(57) ABSTRACT

An arithmetic processing device includes: a memory; and a processor coupled to the memory and configured to: monitor execution statuses for operations in a plurality of accelerators that execute the operations on data stored in a main storage device; and in a case where a delay in data transfer is detected in at least one accelerator among the plurality of accelerators in a monitoring result for the execution statuses, transfer the data compressed with predetermined accuracy to the at least one accelerator from the main storage device.

### CROSS-REFERENCE TO RELATED APPLICATION

This application is based upon and claims the benefit of priority of the prior Japanese Patent Application No. 2024-32999, filed on Mar. 5, 2024, the entire contents of which are incorporated herein by reference.

### FIELD

The embodiments discussed herein are related to an arithmetic processing device and an arithmetic processing method.

### BACKGROUND

There is a continual demand for handling a large amount of data and performing a large amount of arithmetic processing such as those for artificial intelligence (AI) and scientific and technical calculation, and speeding up using accelerators has been performed. For example, speeding up by data parallel processing using a Graphic Processing Unit (GPU) and speeding up specialized for matrix operation involved in machine learning using a tensor processing unit (TPU) are performed.

International Publication Pamphlet No. WO 2023/002546 is disclosed as related art.

### SUMMARY

According to an aspect of the embodiments, an arithmetic processing device includes: a memory; and a processor coupled to the memory and configured to: monitor execution statuses for operations in a plurality of accelerators that execute the operations on data stored in a main storage device; and in a case where a delay in data transfer is detected in at least one accelerator among the plurality of accelerators in a monitoring result for the execution statuses, transfer the data compressed with predetermined accuracy to the at least one accelerator from the main storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying an execution command sequence in which a delay occurs;

FIG. 2 is a block diagram schematically illustrating an exemplary configuration of an arithmetic processing device according to an embodiment;

FIG. 3 is a diagram explaining working of an accelerator after data compression;

FIG. 4 is a diagram exemplifying a program for transferring a calculation result with the original accuracy in a case where data compression transfer has been performed;

FIG. 5 is a diagram exemplifying a program that does not transfer a calculation result with the original accuracy even in a case where data compression transfer has been performed; and

FIG. 6 is a diagram explaining a control process for a transfer interface (IF) at a last level cache (LLC) side.

### DESCRIPTION OF EMBODIMENTS

An accelerator that runs a plurality of accelerators with one device has also appeared, in which a plurality of accelerators can be collectively used as one accelerator and also can be individually used as a plurality of accelerators. For example, the TPU includes a plurality of matrix arithmetic units. In addition, there is also a case where a plurality of coarse-grained reconfigurable architectures (CGRAs) that are each an arithmetic unit including a plurality of arithmetic units and capable of reconfiguring arithmetic contents of each arithmetic unit and data transfer paths between the arithmetic units is provided.

In a case where a plurality of arithmetic units is independently used, data transfer involved in execution is unlikely to be performed in time, causing a bias in a busy rate between individual arithmetic units, and the entire execution time may be possibly delayed.

For example, data involved according to an execution state of a program may not be sometimes placed in a cache. If data is not supplied to a particular arithmetic unit, this results in rate limitation, and the overall execution time is delayed.

In one aspect, an object is to make it possible to mitigate a delay in data transfer in an arithmetic processing device including a plurality of accelerators.

### Embodiments

Hereinafter, embodiments will be described with reference to the drawings. Note that the embodiments to be described below are merely examples, and there is no intention to exclude application of various modifications and techniques not explicitly described in the embodiments. For example, the present embodiment can be variously modified and carried out in a range without departing from the spirit thereof. In addition, each drawing is not intended to include only components illustrated in the drawing and can include another function and the like.

Hereinafter, in the drawings, the same reference signs each indicate a similar part, and thus the description of the similar part will be omitted.

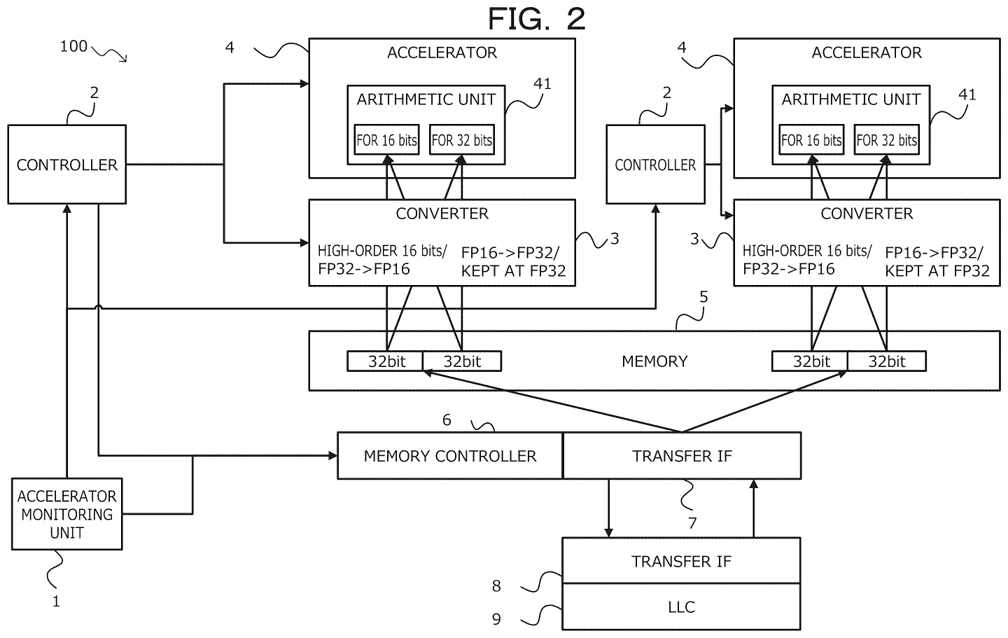

In the present embodiment, in order to mitigate a delay in data transfer, control is performed in which a user defines minimum accuracy of data, and in a case where an execution status of each accelerator 4 (to be described later with reference to FIG. 2) is monitored and it is detected that data transfer is delayed, a system automatically compresses the data with the defined minimum accuracy to transfer the compressed data.

However, even if an executor executes calculation, assuming that lowering the accuracy of the data may not cause any difficulty, degradation of the result deviating from expectations may happen when the calculation is actually conducted.

Thus, in the present embodiment, when data compression has happened, in a case where, for example, compression from floating-point 32-bit format (FP32) to floating-point 16-bit format (FP16) is performed and transfer is done, not only calculation is conducted exclusively with FP16 each other, but also calculation is conducted by up-converting the data of FP16 to FP32, for example, in a case where it is known that there is no problem in performance, as listed in following (1) and (2). Then, the user is allowed to examine a decrease in arithmetic accuracy by comparing the number of occurrences of not a number (NAN) and the results.

By executing the up-conversion, whether the arithmetic result has any problem when performed with low accuracy can be checked.

It takes more time and a further delay is produced by performing up-conversion to conduct calculation although the data transfer is originally delayed and the entire execution is delayed, but it is effective without causing a problem in the following cases (1) and (2).
(1) A case where a disadvantage of conducting calculation with the original accuracy after transfer of an arithmetic result is not large. For example, in a case where all the involved sub-jobs have already been fed and another job is waited to be completed, no problem in performance occurs even if comparison operation is conducted.
(2) A case where there is a request to periodically check the execution accuracy.

Each accelerator 4 executes commands in the order of data loading, execution of calculation, and storing. In the data loading, a plurality of commands is executed. For example, in a case where the product-sum operation (A*B+C) is performed by the matrix operation, load commands for each of the three pieces of data A, B, and C are issued.

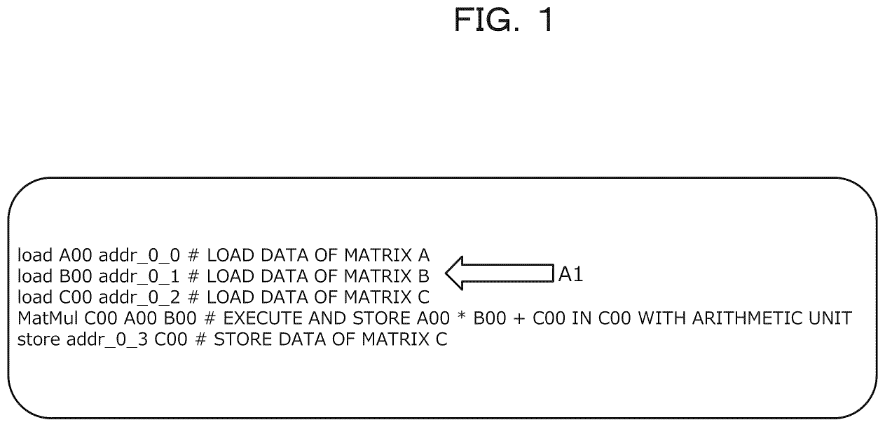

FIG. 1 is a diagram exemplifying an execution command sequence in which a delay occurs.

In the example illustrated in FIG. 1, in the row indicated by the reference sign A1, when it is attempted to load B after loading A in the exemplary matrix operation, the transfer source cache contains no data of B, and loading is kept waiting.

FIG. 2 is a block diagram schematically illustrating an exemplary configuration of an arithmetic processing device 100 according to the embodiment.

The arithmetic processing device 100 includes an accelerator monitoring unit 1, a plurality of (two in the example illustrated in FIG. 2) controllers 2, a plurality of (two in the example illustrated in FIG. 2) converters 3, a plurality of (two in the example illustrated in FIG. 2) accelerators 4, a memory 5, a memory controller 6, transfer interfaces (IFs) 7 and 8, and a last level cache (LLC) 9. The memory 5, the memory controller 6, the transfer IFs 7 and 8, and the LLC 9 are examples of a main storage device. The transfer IF 7 is the transfer IF 7 at the side of the memory controller 6, and the transfer IF 8 is the transfer IF 8 at the side of the LLC 9.

The accelerator monitoring unit 1 is an example of a control unit or a computer and collects accelerator execution statuses from the controller 2 and also notifies the controller 2 of a compression setting. In addition, the accelerator monitoring unit 1 updates a compression control setting for the memory controller 6 according to a status.

The accelerator monitoring unit 1 determines that compression is to be involved in a case where there is a certain number of accelerators 4 that are advanced in execution, as compared with other accelerators 4, by monitoring all the accelerators 4 of the arithmetic processing device 100.

For example, the accelerator monitoring unit 1 monitors the execution statuses for operations in the plurality of accelerators 4 that execute the operations on data stored in the main storage device. Then, in a case where a delay in data transfer is detected in at least one accelerator 4 among the plurality of accelerators 4 in the monitoring result for the execution statuses, the accelerator monitoring unit 1 transfers data compressed with predetermined accuracy to the at least one accelerator 4 from the main storage device.

The controller 2 makes an arithmetic execution instruction to the accelerator 4 and also makes a data accuracy conversion instruction to the converter 3, based on the notification of the compression setting by the accelerator monitoring unit 1. In addition, the controller 2 issues a load instruction to the memory controller 6 by specifying distinction as to being compulsory, acceptable, or inacceptable at the time of issuing the load command.

Being compulsory indicates that compression is desired any time regardless of whether or not the LLC 9 contains data. Being acceptable indicates that the data is compressed in a case where the LLC 9 contains no data at the time of receiving the load command and waits until the data is provided to the LLC 9 from the memory 5. Being inacceptable indicates non-compression.

In a case where the number of accelerators 4 executing commands other than loading is equal to or greater than a threshold value, setting may be made as compulsory or acceptable. Each accelerator 4 raises a counter at the time of execution of the calculation command and lowers the counter at the completion of the calculation command. Being compulsory (compressed any time) and acceptable (compressed if a cache contains none) may be set according to the threshold value.

A compression control signal may be set when the load command is issued, and whether compression is compulsory, acceptable, or inacceptable may be transmitted as a signal when the load command is issued. In addition, a flag indicating whether compression is acceptable or inacceptable may be specified as an input in the load command for the accelerator 4. For example, the compression control signal is used in a case where it is verified that the execution is delayed at the time of issuing the load command and acceleration is involved regardless of a subsequent status change.

In addition, the compression control signal may be altered after the load command is issued and may be dynamically altered as to being compulsory, acceptable, or inacceptable according to the execution status of the accelerator 4. For example, the compression control signal may be used in a case where the execution is not delayed at the time of issuing the load command, but the acceleration is involved thereafter by recognizing a delay.

The LLC 9 transmits compressed data or uncompressed data and compression or non-compression signal to the memory controller 6 via the transfer IF 8.

When transmitting data after data loading to the LLC 9 is finished, the LLC 9 determines whether to compress the data according to the compression setting. In a case where an acceptable signal is transmitted at the time of issuing the load command, data is regularly compressed and transferred when a memory access has occurred due to a cache error irrespective of the execution status of the accelerator 4.

The memory controller 6 arranges the compressed data or uncompressed data at a predetermined position on the memory 5 via the transfer IF 7, according to the compression or non-compression signal from the LLC 9. For example, the 16-bit signal is arranged in the high-order 16 bits of a 32-bit memory area. In addition, the memory controller 6 sets and updates compression control for the loaded data for the LLC 9 and also notifies the LLC 9 of the address and the size of the transfer data via the transfer IF 7.

The converter 3 converts the accuracy of the data according to the data arranged in the memory 5 and outputs the converted data to the accelerator 4. For example, in a case where data is arranged in the high-order 16 bits, the converter 3 converts the accuracy of the data from FP32 to FP16, and in a case where there is a conversion instruction from FP16 to FP32, the converter 3 keeps the data at FP32.

The accelerator 4 includes an arithmetic unit 41. The arithmetic unit 41 executes an operation of the data, using an arithmetic area for 16 bits or an arithmetic area for 32 bits, according to the accuracy of the data input from the converter 3.

In the example illustrated in FIG. 2, an example in which the converter 3 converts the data accuracy between FP32 and FP16 has been described, but this is not restrictive. The converter 3 may convert the data accuracy between floating-point 64-bit format (FP64) and FP32 or between FP64 and FP16, for example.

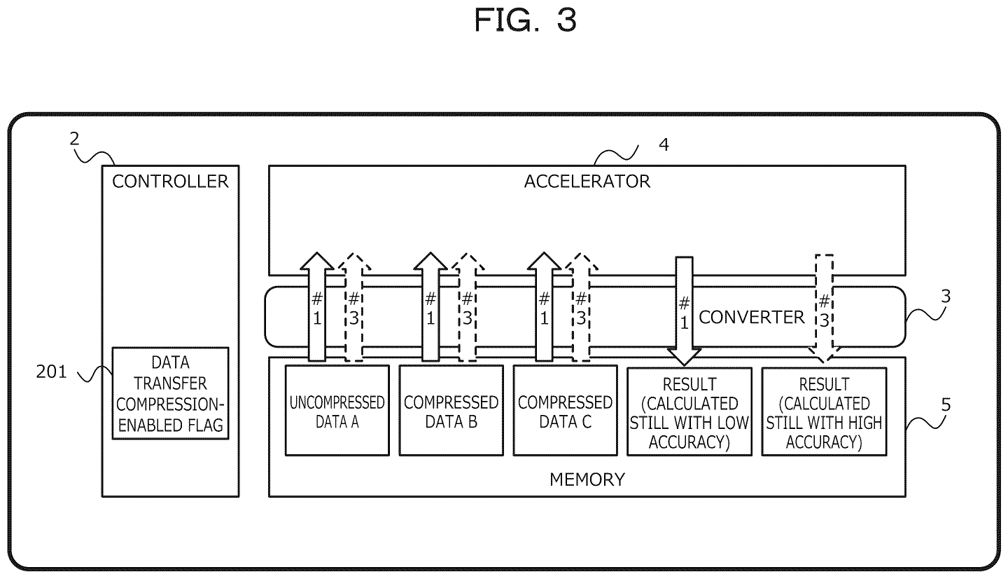

FIG. 3 is a diagram explaining working of the accelerator 4 after data compression.

FIG. 3 illustrates an example in which the data A is uncompressed and the data B and C can be compressed in the execution command sequence illustrated in FIG. 1 in which a delay occurs.

In FIG. 3, the solid line arrows indicate that a same compression process as for the compressed data is performed on the uncompressed data and the compressed data is sent as it is. In addition, the broken line arrows indicate that the uncompressed data is sent as it is and the compressed data is converted into the uncompressed data (for example, missing portions of the mantissa part and the exponent part are padded with zeros).

When executing a calculation execution command indicated by MatMul in FIG. 1, the accelerator 4 first uses the compressed data as it is to execute an operation (see #1 in FIG. 3). Then, when a data transfer compression-enabled flag 201 is set from the controller 2, the accelerator 4 adjusts the compressed data to the same size as the uncompressed data and executes an operation (see #3 in FIG. 3).

At the time of execution of a store command indicated by store in FIG. 1, the accelerator 4 transfers a result of calculation with low accuracy when accepting the transferred flag for enabling or disabling data transfer compression from the controller 2.

Note that, in executing the store command, the store command is executed without waiting for the completion of the execution of #3 of the calculation execution command. For example, the store command is executed in the background of #3 of the calculation execution command.

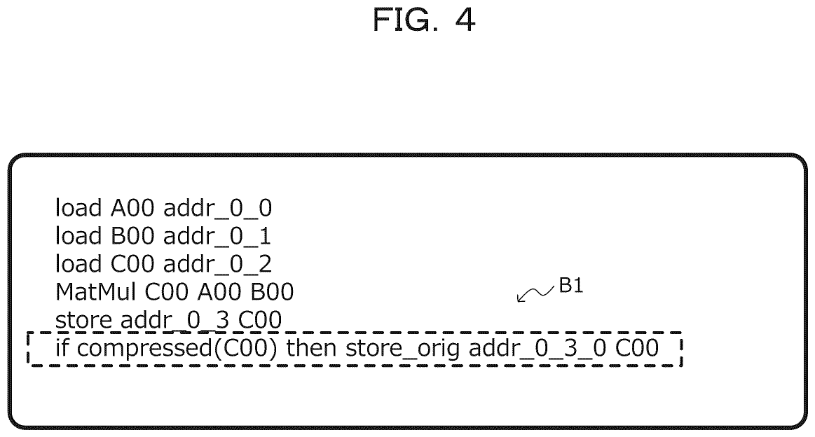

When instructing the accelerator 4 on execution, the controller 2 specifies to cause the accelerator 4 to additionally issue a transfer command execution for the calculation result with the original accuracy if applicable when the data transfer compression-enabled flag 201 is recognized to be set at the time of transfer of the execution result. A program for transferring the calculation result with the original accuracy in a case where the data compression transfer has been performed will be described later with reference to FIG. 4.

If a transfer command for the calculation result with the original accuracy is executed during the execution of #3 of the calculation execution command for data having the same size as the uncompressed data in the accelerator 4, the execution of the transfer command for the calculation result with the original accuracy is terminated until the execution of the calculation with the original accuracy is completed. Since the execution is by the accelerator 4 that was delayed by then, it is usually not desirable to take more time, but a request to instruct #3 of the calculation execution command is also expected in cases such as the following case (1) or (2).
(1) A case where no performance problem arises as in a case where all the involved sub-jobs have already been fed and another job is waited to be completed.
(2) A case where a system is designed so as to sample and acquire an arithmetic result when compressed.

For example, in a case where at least one accelerator 4 stands by for an arithmetic execution result of another accelerator 4, the accelerator monitoring unit 1 may up-convert the data that has been compressed, to accuracy higher than the predetermined accuracy, and cause the at least one accelerator 4 to execute an operation.

In addition, when examining the accuracy of the arithmetic execution results in the plurality of accelerators 4, the accelerator monitoring unit 1 may up-convert the data that has been compressed, to accuracy higher than the predetermined accuracy, and cause at least one accelerator 4 to execute an operation.

Note that, in a case where the calculation result with the original accuracy is not transferred, a command for loading or next calculation execution is issued, and #3 of the calculation execution command being executed at that time is stopped.

FIG. 4 is a diagram exemplifying a program for transferring a calculation result with the original accuracy in a case where data compression transfer has been performed.

In the row indicated by the reference sign B1 in FIG. 4, the controller 2 specifies to cause the accelerator 4 to issue an acquisition command for the calculation result with the original accuracy in a case where the data is compressed.

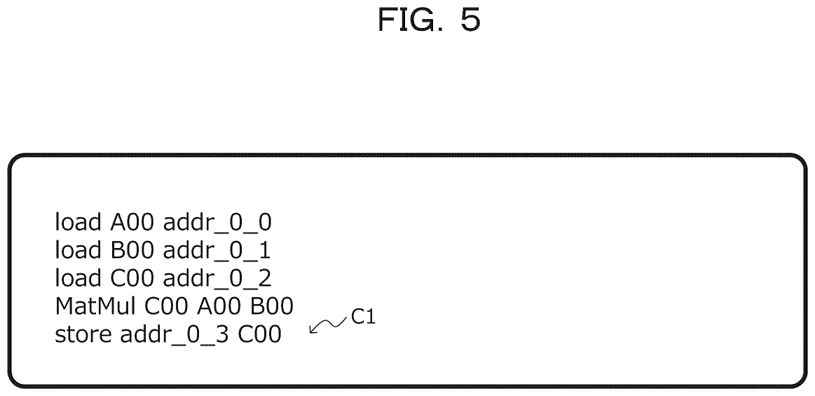

FIG. 5 is a diagram exemplifying a program that does not transfer a calculation result with the original accuracy even in a case where data compression transfer has been performed.

In the row indicated by the reference sign C1 in FIG. 5, the controller 2 does not issue the acquisition command for the calculation result with the original accuracy to the accelerator 4 and thus instructs the accelerator 4 to suspend the arithmetic execution with the original accuracy being executed, with the next load command or a MatMul execution command.

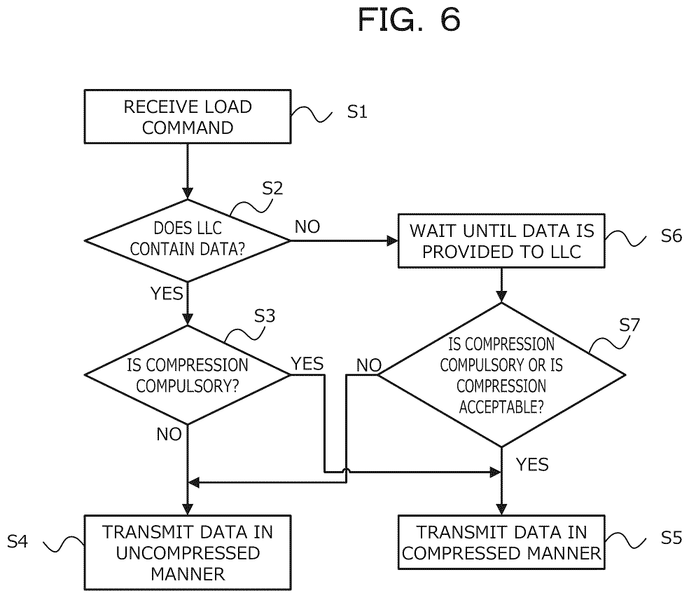

A control process of the transfer IF 8 at the side of the LLC 9 will be described in accordance with the flowchart (steps S1 to S7) illustrated in FIG. 6.

The transfer IF 8 receives the load command (step S1).

The transfer IF 8 determines whether the LLC 9 contains data (step S2).

In a case where the LLC 9 contains data (see the Yes route in step S2), the transfer IF 8 determines whether compression of the data is compulsory (step S3).

In a case where compression of the data is not compulsory (see the No route in step S3), the transfer IF 8 transmits the data in an uncompressed manner (step S4). Then, the control process of the transfer IF 8 at the side of the LLC 9 ends.

In step S2, in a case where the LLC 9 contains no data (see the No route in step S2), the transfer IF 8 waits until the data is provided to the LLC 9 (step S6).

The transfer IF 8 determines whether compression of the data is compulsory or compression of the data is acceptable (step S7).

In a case where neither compression of the data is compulsory nor compression of the data is acceptable (for example, compression is inacceptable) (see the No route in step S7), the process proceeds to step S4.

On the other hand, in a case where compression of the data is compulsory or compression of the data is acceptable (see the Yes route in step S7), the process proceeds to step S5.

### Effects

According to the arithmetic processing device and the arithmetic processing method in the embodiments described above, for example, the following action effects may be obtained.

The accelerator monitoring unit 1 monitors the execution statuses for operations in the plurality of accelerators 4 that execute the operations on data stored in the main storage device. In a case where a delay in data transfer is detected in at least one accelerator 4 among the plurality of accelerators 4 in the monitoring result for the execution statuses, the accelerator monitoring unit 1 transfers data compressed with predetermined accuracy to the at least one accelerator 4 from the main storage device.

This may mitigate a delay in data transfer in the arithmetic processing device 100 including the plurality of accelerators 4.

In a case where at least one accelerator 4 stands by for an arithmetic execution result of another accelerator 4, the accelerator monitoring unit 1 up-converts the data that has been compressed, to accuracy higher than the predetermined accuracy, and causes the at least one accelerator 4 to execute an operation.

This may enable to acquire an arithmetic result with high accuracy in a case where no performance problem arises as in a case where all the involved sub-jobs have already been fed and another job is waited to be completed.

When examining the accuracy of the arithmetic execution results in the plurality of accelerators 4, the accelerator monitoring unit 1 up-converts the data that has been compressed, to accuracy higher than the predetermined accuracy, and causes at least one accelerator 4 to execute an operation.

This may enable to acquire an arithmetic result with high accuracy in a case where a system is designed so as to sample and acquire an arithmetic result when compressed.

### Others

The disclosed technique is not limited to the embodiments described above, and various modifications can be made and carried out without departing from the spirit of the present embodiment. Each configuration and each process of the present embodiment can be selected or omitted if applicable, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
a memory; and
a processor coupled to the memory and configured to:
monitor execution statuses for operations in a plurality of accelerators that execute the operations on data stored in a main storage device; and
in a case where a delay in data transfer is detected in at least one accelerator among the plurality of accelerators in a monitoring result for the execution statuses, transfer the data compressed with predetermined accuracy to the at least one accelerator from the main storage device.

2. The arithmetic processing device according to claim 1, wherein
in a case where the at least one accelerator stands by for arithmetic execution results of another accelerator, the processor up-converts the data that has been compressed, to accuracy higher than the predetermined accuracy, and causes the at least one accelerator to execute the operations.

3. The arithmetic processing device according to claim 1, wherein
when examining the accuracy of arithmetic execution results in the plurality of accelerators, the processor up-converts the data that has been compressed, to accuracy higher than the predetermined accuracy, and causes the at least one accelerator to execute the operations.

4. An arithmetic processing method comprising:
monitoring execution statuses for operations in a plurality of accelerators that execute the operations on data stored in a main storage device; and
in a case where a delay in data transfer is detected in at least one accelerator among the plurality of accelerators in a monitoring result for the execution statuses, transferring the data compressed with predetermined accuracy to the at least one accelerator from the main storage device.

5. The arithmetic processing method according to claim 4 further comprising:
in a case where the at least one accelerator stands by for arithmetic execution results of another accelerator, up-converting the data that has been compressed, to accuracy higher than the predetermined accuracy; and
causing the at least one accelerator to execute the operations.

6. The arithmetic processing method according to claim 5 further comprising:
when examining the accuracy of arithmetic execution results in the plurality of accelerators, up-converting the data that has been compressed, to accuracy higher than the predetermined accuracy; and
causing the at least one accelerator to execute the operations.
